(19) United States
(12) Patent Application Publication
(10) Pub. No.: US 2015/0082841 A1
(43) Pub. Date: Mar. 26, 2015

(54) ANTI-THEFT DEVICE HAVING A FLEXIBLE COUPLING

(71) Applicant: DECATHLON, VILLENEUVE D'ASCQ (FR)

(72) Inventors: Clément Lebeaume, Lambersart (FR); Kwasi Tabury, Mons-En-Baroeul (FR); Jean-Sébastien Tronchon, Lille (FR)

(21) Appl. No.: 14/398,478

(22) PCT Filed: Jun. 14, 2013
(86) PCT No.: PCT/FR2013/051400

§ 371 Date: Nov. 3, 2014

(30) Foreign Application Priority Data
Jun. 14, 2012 (FR) 12 55572

(51) Int. Cl. E05B 71/00; E05B 65/00; E05B 73/00; E05B 63/00

(52) U.S. Cl. CPC E05B 71/00; E05B 63/00; E05B 65/00; E05B 73/0005
USPC 70/15

(57) ABSTRACT

The invention provides an anti-theft device of the collar type comprising a flexible line (12) composed of reinforcing elements (26, 28) embedded in a thickness of elastomer material (24), said reinforcing elements (26, 28) being arranged in the elastomer material (24) so as to confer to said flexible line flexibility and overall cut resistance.

The invention is characterized by the fact that at least some of said reinforcing elements (26, 28) are spaced from each other, so that they are totally encompassed by the elastomer material (24).

### BACKGROUND OF THE INVENTION

The present invention relates to an anti-theft device designed for a vehicle provided with at least two wheels. In particular the invention finds an application for slowing down or preventing theft of a bicycle.

Anti-theft devices of the collar type are known that are constituted by a strand of metal cable that is suitable for being covered with a sheath of plastics material, each end of which is provided with a closure element; the closure elements co-operate with each other to form an anti-theft lock. The lock is then locked by means of a key or any other locking system. By fastening one of the wheels of the vehicle to an element of its frame and/or to a stationary support, the closed anti-theft device thus makes it possible to obstruct movement of the vehicle.

The problem posed by this type of anti-theft device is that the improvement of its overall resistance to being cut through leads to a reduction in its flexibility; in order to make the anti-theft device more resistant, it is indeed necessary to increase the diameter of the strand. Consequently, its flexibility is reduced, and in the same way, its use, its storage, and its transport may be made difficult.

An alternative solution to the use of a single strand is proposed by document EP 0 102 933, which describes a flexible fastening strap constituted by an elastomer material in which a plurality of longitudinally extending twisted metal cables are embedded, the cables being twisted around each other. By way of example, that device is used to fasten objects in secure manner on the roof of a vehicle. However, that solution does not resolve the above-mentioned problem: it gives priority to strap flexibility in order to enable it to be effective in fastening items having a variety of shapes, rather than to its overall ability to withstand cutting or “cut resistance”, which is determined by the diameter of the individual cables making it up.

### OBJECT AND SUMMARY OF THE INVENTION

The present invention aims to improve both the overall cut resistance and the flexibility of the anti-theft device.

This aim is achieved by the fact that the invention relates to an anti-theft device of the collar type comprising a flexible line made up of reinforcing elements embedded in a thickness of elastomer material, wherein the reinforcing elements are arranged so as to confer to said flexible line a satisfactory compromise between flexibility and overall cut resistance, at least some of the reinforcing elements being spaced from each other, so that they are totally encompassed by the elastomer material.

Preferably, the reinforcing elements are totally encompassed along their full length.

Preferably, the reinforcing elements are encompassed by elastomer material along at least 75% of their length.

The term “cutting” refers to any action aiming to break the continuity of the anti-theft device by means of, by way of example and in non-limiting manner, pliers, a saw, a blowtorch, or any other device attempting to compromise the integrity of the anti-theft line.

Thus, this anti-theft device presents great flexibility due to the use of the elastomer, yet without making the device vulnerable. In addition, using an elastomer to connect the intrinsic elements to the anti-theft structure ensures that the structure is not damaging to the vehicle, nor to its user, nor to the support to which the vehicle is secured.

It is thus understood that at least some of the reinforcing elements are separated from each other by the elastomer material; in other words, the different reinforcing elements are distributed in the flexible line so that the elastomer material binds them together, i.e. at least some of the reinforcing elements do not contact each other, except possibly at the ends of the flexible line, the elastomer material constituting the binding element of the reinforcing elements.

At least some of the reinforcing elements are thus isolated from each other, in order to arrange the reinforcing elements in the flexible line so as to increase its cut resistance without jeopardizing its flexibility.

Preferably, and in non-limiting manner, the reinforcing elements embedded in the elastomer are cables. The reinforcing elements may also be constituted by spiral springs, a metal mesh, textile straps, a chain constituted by a plurality of links, or of any other element that is suitable for being embedded in a thickness of elastomer material and presenting both characteristics of cut resistance, which make it dissuasive to potential thieves, and characteristics of flexibility, which make it possible for the anti-theft device to be used, stored, and transported without difficulty.

The diversity of reinforcing elements embedded in the elastomer makes it possible, within a single anti-theft device, to unite reinforcing elements presenting, among other properties, a variety of properties of cut resistance and flexibility. In addition, this diversity increases the number of different tools that need to be used in order to cut through the anti-theft device, and in this way improves its resistance to attempts at cutting.

Below, the invention is described in a series of variant embodiments that may be considered singly or in combination with one or more of the preceding embodiments.

Preferably, at least some of the reinforcing elements extend longitudinally in the flexible line, in a substantially parallel manner to each other.

By means of this arrangement, the reinforcing elements are disposed in a homogeneous manner regardless of the section of the considered flexible line, so as to have homogeneous cut resistance and flexibility properties.

Advantageously, the reinforcing elements present selected differing cut-resistance characteristics.

The various properties of the reinforcing elements constituting the anti-theft device make it possible to arrange them within the elastomer material in such a manner as to ensure that the device as a whole presents flexibility and resistance to cutting.

In addition, the differing properties of the different reinforcing elements enable them to impede the action of differing devices that could be used to compromise their integrity. By way of example and in non-limiting manner, some reinforcing elements may present properties that are particularly adapted to withstand the action of a saw, while other reinforcing elements may present properties that are particularly adapted to withstand the action of pliers. Thus, the diversity of the reinforcing elements embedded in the elastomer enable the anti-theft device to withstand the action of a wide range of cutting means.

In advantageous manner, at least some reinforcing elements of superior cut resistance are located at the periphery of the flexible line.

This location makes it possible to present cutting tools with the reinforcing elements that are the most difficult to cut and thus to slow down or prevent the theft of the vehicle locked by the anti-theft device.

Preferably, at least some of the reinforcing elements located at the periphery of said flexible line are constituted by a material that is different from the material of other reinforcing elements.

The composition of the reinforcing elements arranged at the periphery of the flexible line thus makes it possible to present cutting tools with reinforcing elements of section that is not necessarily greater that that of the reinforcing elements arranged in the core of the line so as to avoid reducing the overall flexibility of the line.

Advantageously, at least some of said reinforcing elements arranged at the periphery of the flexible line present sections that are greater than at least some of the reinforcing elements arranged in the core of said flexible line.

This distribution of the reinforcing elements makes it possible to arrange the reinforcing elements presenting greater flexibility in the core of the flexible line, in this way facilitating the use, transport, and storage of the anti-theft device.

In advantageous manner, the reinforcing elements arranged in the core of said flexible line surround at least one reinforcing element of greater section.

The presence of a reinforcing element of greater section in the core of the line thus makes it possible to reinforce the overall strength of the anti-theft device; by way of example, it is therefore very difficult to bend the anti-theft device in order to cut it in the middle.

Preferably, said at least one reinforcing element of greater section is a flat strip.

The shape of the reinforcing element of greater section makes it possible to cause potential attempts at cutting to be complex, because of the specific tools that are required.

Advantageously, said at least one reinforcing element of greater section is of helical shape.

The shape of the reinforcing element of greater section enables the anti-theft device to retain its flexible properties.

In advantageous manner, the reinforcing elements arranged in the core of said flexible line surround at least two reinforcing elements of greater section arranged side by side.

By arranging two reinforcing elements of greater section in the core of the line, the anti-theft device makes it possible to extend the zone of greater cut resistance.

Preferably, the section of the line is substantially rectangular.

This shape, where the width of the anti-theft device is greater than its thickness, makes it possible to increase the difficulty of cutting by means of conventional tools. Thus, the sharpened portion of a pair of pliers would have difficulty covering the entire width of the anti-theft device; the thief would therefore need to perform several successive cuts in order to cut the line.

The thickness of the anti-theft device should also make it possible to reduce the grip that conventional cutting tools may have, the sharpened part of the tool used by the thief thus having difficulty covering the entire thickness of the anti-theft device. In the same way, the thickness of the anti-theft device should be such that the anti-theft device can be passed through the spokes of a wheel and retain flexibility that is sufficient to enable it to be used, stored, and transported without difficulty. Preferably and in non-exclusive manner, the thickness of the anti-theft device corresponds to the maximum opening diameter of a conventional cutting tool, such as a pair of pliers.

In advantageous manner, the line presents longitudinal edges, at least one of which edges is beveled.

Preferably, the reinforcing elements of superior cut resistance are arranged close to said longitudinal edges.

This configuration also enables the cutting operation to be made more difficult, by increasing the contact area between the cutting tool and the flexible line.

Preferably, the reinforcing elements embedded in the elastomer material are made of metal.

The material selected also makes it possible to increase the difficulty of cutting, by offering an advantageous resistance/section ratio.

Advantageously, each end of the flexible line is provided with a closure element.

In advantageous manner, the closure elements are provided with openings in which the reinforcing elements are engaged, the reinforcing elements being secured to the closure elements.

By way of non-limiting example, the reinforcing elements are fastened to the closure elements by pressing the closure elements. An anti-theft device in which the reinforcing elements are fastened to the closure elements by other means could also be envisaged, such as for example a hook formed on the closure elements that pass through a fraction of the reinforcing element, without going beyond the ambit of the invention.

This assembly of reinforcing elements and of closure elements makes it possible to avoid the presence of connection means between the reinforcing elements and the closure elements, which would weaken the anti-theft device.

Preferably, one of the closure elements is of male type, the other is of female type and the closure elements co-operate with each other to constitute a latch.

Thus, the anti-theft device is able to close in order to constitute a continuous line, enabling it to fulfill its function. The closure of the anti-theft device enables its user to fasten the wheel of the bicycle to its frame, in order to obstruct movement of the vehicle. Alternatively, the user may fasten a portion of the bicycle (its frame or one of its wheels, for example) to a stationary support (an urban device provided for this purpose, a signpost, or a tree, for example).

In advantageous manner, the latch constituted by the association of said closure elements is lockable.

Thus, once the closure elements are associated with each other, the user proceeds with locking the latch. Locking may be performed by means of a key, or of a system of dials making it possible to form a code.

In advantageous manner, the invention further provides anti-theft equipment comprising an anti-theft device according to the invention and two attachment elements suitable for being fastened on the vehicle to be secured.

In order to facilitate transport of the anti-theft device, attachment elements are fastened on the bicycle and co-operate with the closure elements of the anti-theft device. Thus, during movement of the vehicle or, more generally, when the anti-theft device is open, it can be latched attached to the frame of the bicycle, thereby not running the risk, for example, of accidentally obstructing its movement.

By way of example and in non-limiting manner, the attachment elements may consist of self-gripping elements that co-operate with the anti-theft device, or of straps making it possible to hold the anti-theft device when it is attached on the frame of the bicycle.

Preferably, the invention finally provides anti-theft equipment comprising an anti-theft device of the invention and two additional closure elements of male and female type suitable for being fastened on a vehicle to be secured.

With the same aim of facilitating transport of the anti-theft device, closure elements similar to those arranged at the ends of the flexible line are fastened to the bicycle and may co-operate with the closure elements of the anti-theft device. Thus, the open anti-theft device may be locked on the frame of the bicycle. The closure elements of the anti-theft device co-operate with the closure elements arranged on the bicycle in the same manner that they co-operate with each other at the moment the anti-theft device is being closed, in order to avoid the anti-theft device becoming detached involuntarily, or stolen when it is not closed.

### BRIEF DESCRIPTION OF THE DRAWINGS

Other characteristics and advantages of the invention appear more clearly and more completely on reading the description given below of several preferred embodiments, provided by way of non-limiting examples and with reference to the accompanying drawings, in which:

FIG. 1 is a diagram showing an example of an anti-theft device of the invention, before closing and locking said device;

FIGS. 2A to 2H are diagrams showing a section of several embodiments of the flexible line of the invention;

FIGS. 3A and 3B are diagrams showing an assembly of the reinforcing elements and of one of the closure elements of the anti-theft device of the invention;

FIG. 4 is a diagram showing an example anti-theft device of the invention, after closing and locking said device, the bicycle being secured to a stationary support; and

FIG. 5 is a diagram showing an example anti-theft device of the invention, open and in the transport position, after locking the anti-theft device to the closure elements fastened to the frame of the bicycle.

### DETAILED DESCRIPTION OF THE INVENTION

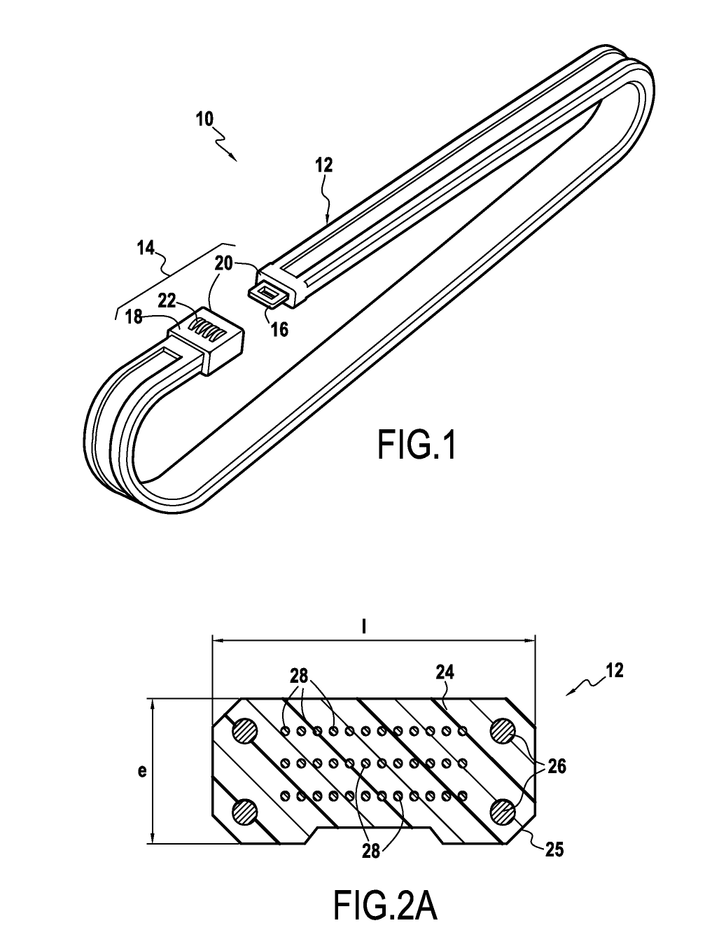

In the example shown in FIG. 1, the anti-theft device 10 of the invention presents a first portion constituted of a flexible line 12, designed to fasten one or more elements of the vehicle together or to one or more elements surrounding the vehicle, and a second portion 14 designed to close and lock the flexible line 12.

The second portion 14 of the anti-theft device comprises a male element 16 and a female element 18, designed to cooperate with each other in order to constitute the latch 20 of the anti-theft device and to close the device. In the example shown, the latch 20 of the anti-theft device is locked by a dial system 22 making it possible to form a code, arranged on the female element 18 of the second portion 14 of the anti-theft device.

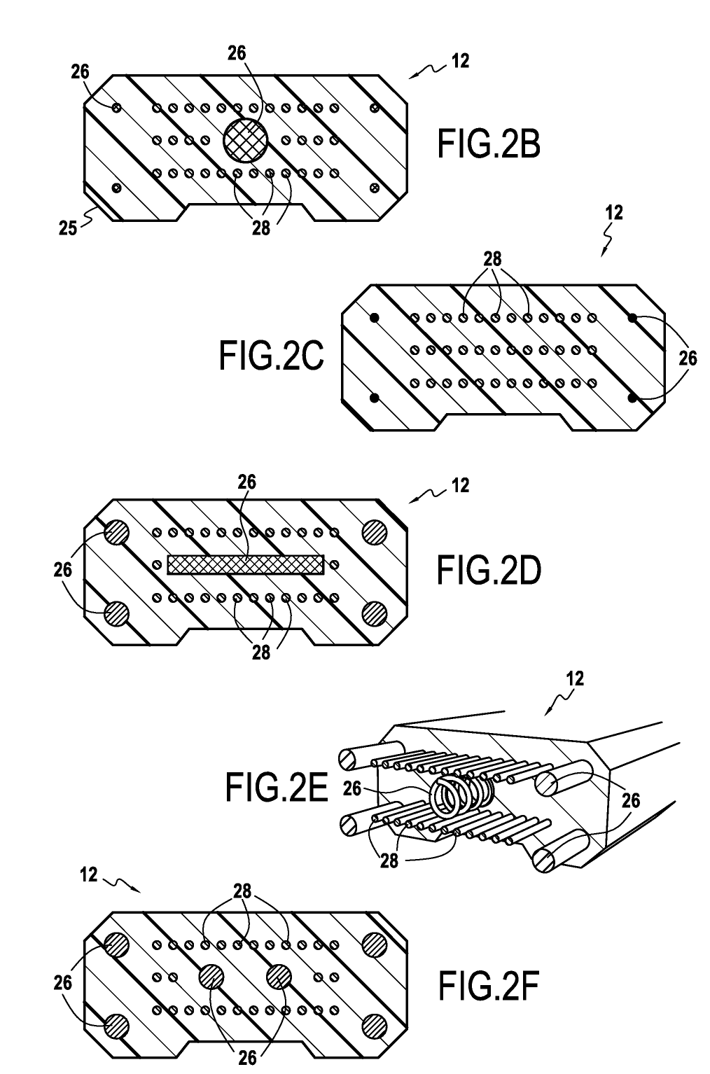

FIG. 2A shows a cross-section of an example of a line 12 of the invention.

In the example shown, the section is of substantially rectangular shape, i.e. such that its width, having reference λ, is greater than its thickness, having reference e; in the example shown, the longitudinal edges 25 of the flexible line 12 are beveled.

As shown in FIG. 2A, the device comprises reinforcing elements 26, 28 of a plurality of different sections that are embedded in elastomer material 24. In the non-limiting example shown, only two different reinforcing element sections are provided, i.e. a first series of reinforcing elements 26 of greater section, and a second series of reinforcing elements 28 of smaller section. The reinforcing elements of greater section 26 are arranged at the periphery of the line; in the example of the line section of substantially rectangular shape shown by FIG. 2A, the reinforcing elements 26 of greater section are situated close to the longitudinal edges 25 of the flexible line 12.

The reinforcing elements 26 of greater section are separated from each other and define a space in the center of the line; in this space the reinforcing elements 28 of smaller section are arranged, which are also embedded in the elastomer material 24 and preferably separated from the reinforcing elements 26 of greater section.

In this example of the line 12 according to the present invention, the reinforcing elements 26 and 28 are made of metal and extend longitudinally in the line, substantially parallel to each other.

By way of example, the reinforcing elements 26 of greater section are steel cables of 3 millimeters (mm) in diameter constituted of seven strands of seven wires and the reinforcing elements 28 of smaller section are, for example, wire drawn steel cables of 1 mm diameter.

As shown in FIG. 2A, the reinforcing elements 26, 28 are cables; however, without going beyond the ambit of the invention, it is possible to envisage reinforcing elements constituted by spiral springs, a metal mesh, or by textile straps, or by any other element that is suitable for being embedded in a thickness of elastomer material 24 and presenting both characteristics of cut resistance, that makes it dissuasive to potential thieves, and characteristics of flexibility, that make it possible for the anti-theft device 10 to be used, stored, and transported without difficulty.

As shown in FIG. 2A, the cut resistance of the reinforcing element is proportional to its section or to its diameter while the flexibility of the reinforcing element is inversely proportional to its section. As appears more clearly in the description of FIGS. 2B to 2H, it could be envisaged to distribute, within the thickness of the elastomer 24, reinforcing elements of identical section, but presenting different flexibility and cut resistance properties, without going beyond the ambit of the present invention. Thus, the disposition of the reinforcing elements in the thickness of the elastomer 24 aims, among other things, to confer to the anti-theft device a satisfactory compromise between flexibility and overall cut resistance.

FIGS. 2B to 2H show other embodiments of the line 12 of the present invention.

In the example shown in FIG. 2B, the device comprises reinforcing elements 26 of greater cut resistance arranged at the periphery of the line 12, close to each of the beveled edges 25, the reinforcing elements 26, separated from each other, extending longitudinally in the flexible line 12, substantially parallel to each other.

In the space defined by these reinforcing elements 26 of greater cut resistance, reinforcing elements 28 of greater flexibility are arranged which extend longitudinally in the flexible line 12, preferably in a substantially parallel manner to each other, and being preferably separated from the reinforcing elements 26 of greater cut resistance by the elastomer 24.

Finally, a reinforcing element 26 of greater cut resistance is arranged in the center of the line 12, surrounded in a disjoint manner by reinforcing elements 28 of greater flexibility.

By means of this arrangement of reinforcing elements 26, 28, the device 10 benefits both from resistance to conventional cutting tools seeking to attack the line 12 via one of its side edges 25, and from flexibility facilitating its use, its storage, and its transport.

Finally, the presence of a reinforcing element of greater section 26 in the center of the line 12 thus makes it possible to reinforce the overall resistance of the anti-theft device 10; by way of example, it is therefore very difficult to bend the anti-theft device in order to cut it in the middle.

It should be noted that as shown in FIG. 2B, various reinforcing elements 26 of greater cut resistance do not necessarily present the same section; reinforcing elements constituted by various materials and presenting different sections, but that benefit from similar cut resistance properties may be envisaged, without going beyond the ambit of the present invention. In similar manner, reinforcing elements constituted by various materials and presenting different sections, but that benefit from similar flexibility properties may be envisaged, without going beyond the ambit of the present invention.

In the example shown in FIG. 2C, the device comprises reinforcing elements 26 of greater cut resistance arranged at the periphery of the line, separated from each other, extending longitudinally in the flexible line 12, in a substantially parallel manner to each other, and reinforcing elements 28 of greater flexibility, extending also in a substantially parallel manner to each other, that are arranged in the space defined by the reinforcing elements 26 of greater cut resistance, the reinforcing elements 28 of greater flexibility being separated from the reinforcing elements 26 of greater cut resistance by the elastomer 24.

It should be observed that, as shown in this figure, the reinforcing elements 26 and 28 may present identical sections, but different properties of flexibility and cut resistance.

As shown in FIGS. 2D and 2E, the reinforcing elements are not necessarily cables.

Thus, in the example shown in FIG. 2D, the reinforcing element 26 of greater cut resistance arranged in the core of the line 12 is constituted by textile straps, the section of which may be rectangular, as shown in this example, or in any other form enabling it to be embedded in an elastomer material 24.

In the example shown in FIG. 2E, the reinforcing element 26 of greater cut resistance arranged in the core of the line 12 is constituted by a spiral spring.

Without going beyond the ambit of the invention, reinforcing elements 28 of greater flexibility could be envisaged that would be constituted by textile straps, spiral springs, a metal mesh, or any other element meeting the flexibility requirements of the present invention and that is suitable for being embedded in the elastomer material 24.

In the example shown in FIG. 2F, two reinforcing elements 26 of greater cut resistance are arranged in the core of the line 12, that are separated from each other et that extend longitudinally in the flexible line 12, in a substantially parallel manner.

In the example shown in FIGS. 2G and 2H, three reinforcing elements 26 of greater cut resistance are arranged in the core of the line 12. A chain constituted by a plurality of links is arranged substantially in the center of the line 12; the chain is surrounded by two cables arranged on either side of the chain, close to the edges 25 of the line 12, the three reinforcing elements 26 of greater cut resistance being separated from each other by the elastomer 24. The presence of a chain in the core of the line 12 ensures that the anti-theft device 10 has a flexibility facilitating its transport, its storage, and its use.

As shown on the different embodiments that are described by reference to FIGS. 2A to 2H, the reinforcing elements 26, extend longitudinally in the flexible line 12, in a substantially parallel manner to each other. They define, for instance and in a non-limiting manner, rows that also extend in a substantially parallel manner to each other. The embodiments that are represented by FIGS. 2A to 2F also have, for instance and in a non-limiting manner, two sets of rows that extend in a substantially parallel manner along the longitudinal direction of the flexible line 12, the rows of the first set being transverse, preferably perpendicular, to the rows of the second set.

It can thus be considered that the reinforcing elements 26, 28 disposed next to each other in the flexible line 12 define channels, the reinforcing elements being separated by the elastomer material 24; as shown in particular on FIGS. 2A to 2F, such channels extend along surfaces that are perpendicular to the bending direction of the flexible line 12, when it is bended, for instance to be locked. The surface that is defined by the channels is thus substantially perpendicular to the thickness e of the flexible line 12. Moreover, the channels that are defined by the reinforcing elements 26, 28 extend along surfaces that are substantially parallel to each other, and help to increase the cut resistance without jeopardizing the flexibility.

For instance and in a non-limiting manner, the mesh formed by the reinforcing elements 26, 28 distributed in the elastomer material 24 has a greater concentration of reinforcing elements 26, 28 considered in the width 1 than considered in the thickness e.

Moreover, as it has been previously mentioned by reference to the different figures, at least some of the reinforcing elements 26, 28 are spaced from each other in the elastomer material 24, so that the reinforcing elements 26, 28 are isolated from each other and are totally encompassed by the elastomer material 24.

The embodiments of the line 12 shown in FIGS. 2A to 2H are not limiting; any combination or any variation of the examples described above is also covered by the present invention.

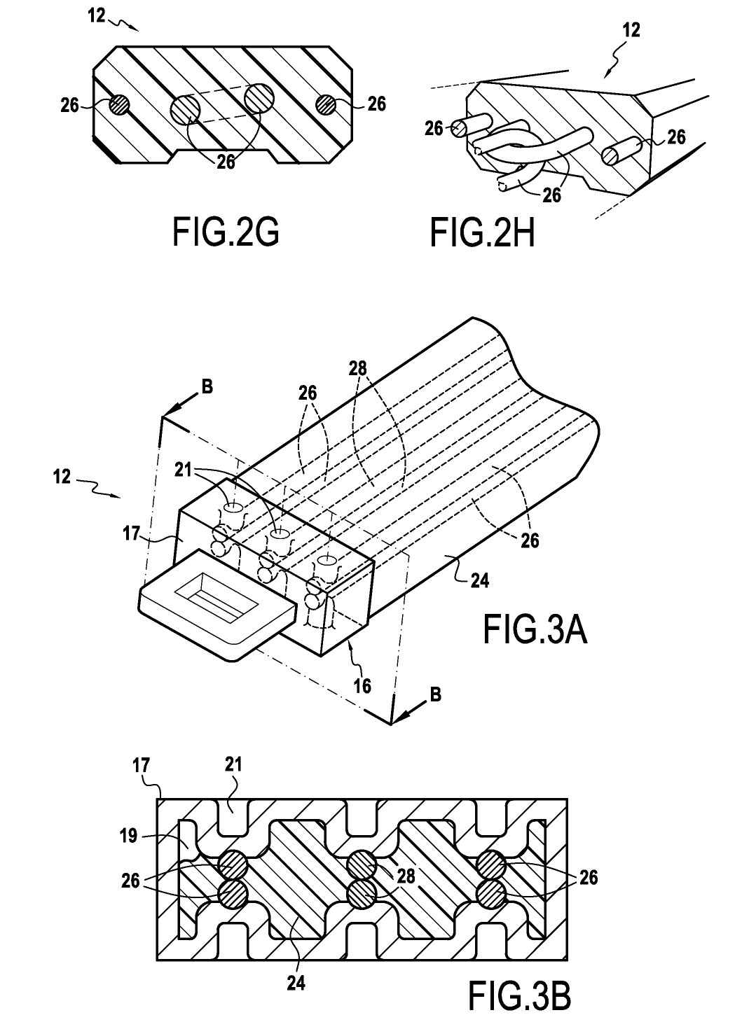

FIG. 3A is a diagram of the assembly of the flexible line 12 and of the closure element 16.

The reinforcing elements 26, 28 embedded in the elastomer material 24 are shown in dotted line. In the example shown, the closure element 16 co-operates with the flexible line 12 of rectangular section and itself comprises a fraction 17 of rectangular shape in which orifices 21 are formed that are suitable for being arranged, as shown in this example, on each length of the rectangular fraction 17 of the closure element 16.

FIG. 3B shows a cross-section along plane B of FIG. 3A.

As shown in FIG. 3B, the fraction 17 of the closure element 16 includes an opening 19 in which the reinforcing elements 26, 28 engage. The reinforcing elements 26, 28 that extend longitudinally and in a substantially parallel manner to each other are then secured to the fraction 17 of the closure element 16 at the moment of fabrication of the anti-theft device 10 by a pressing operation.

As shown in FIG. 3B, pressing the reinforcing elements 26, 28 in the fraction 17 of the closure element 16 is performed by the action of a press through the orifices 21. Thus, the material constituting the fraction 17 of the closure element 16 is pushed towards the opening 19 of the fraction 17 of the closure element 16; the reinforcing elements 26, 28 engaged in the opening 19 are clamped by the material arranged around the opening 19.

As shown in FIG. 3B, pressing is performed by means of orifices 21 formed in the fraction 17, on either side of the opening 19; a pressing operation implemented by a series of orifices 21 formed in a single side of the fraction 17 of the closure element 16 may nonetheless be envisaged without going beyond the ambit of the present invention.

Once the reinforcing elements 26, 28 are secured to the closure element 16 by pressing, the assembly is placed in a vulcanizing mold that enables the elastomer material 24 to coat the reinforcing elements 26, 28 and to fill the space of the opening 19 remaining after the pressing operation. No means for connecting the flexible line 12 to the closure element 16 are therefore necessary, where such a connection could possibly constitute a zone of weakness for the anti-theft device 10.

The flexible line 12 is thus made of a plurality of reinforcing elements 26, 28 that extend longitudinally in the flexible line 12, in a substantially parallel manner to each other.

For instance, and in a non-limiting manner, the reinforcing elements 26, 28 are separately distributed in the flexible line 12; in other words, the reinforcing elements 26, are separated from each other by the elastomer 24. The elastomer 24 thus constitutes a matrix in which the reinforcing elements 26, 28 can be distributed in different manners, as previously described with reference to FIGS. 2A to 2H.

It is then understood that the elastomer 24 is arranged to distribute the reinforcing elements 26, 28 in the flexible line 12, based, on the one hand, on the aimed flexibility and resistance characteristics and, on the other hand, on the characteristics of the different reinforcing elements 26, 28.

Assembly of the flexible line 12 to the second closure element 18 is performed according to the same principle.

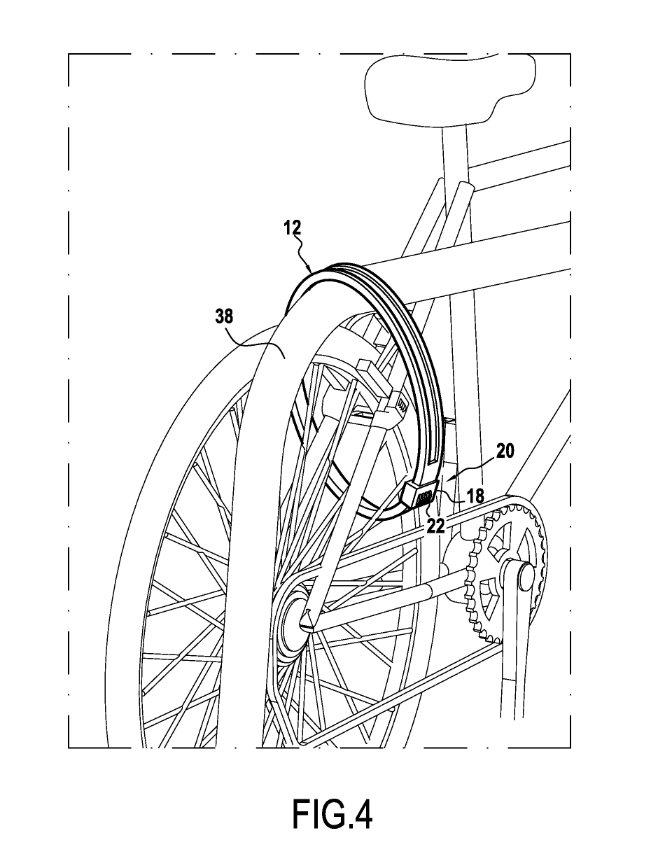

FIG. 4 shows the anti-theft device 10 of the invention, after closure and locking of the anti-theft device; in this figure, the latch 20 constituted by the combination of elements 16 and 18 has been locked by means of the dial system 22. The wheel and the bicycle frame are also secured to a stationary support 38.

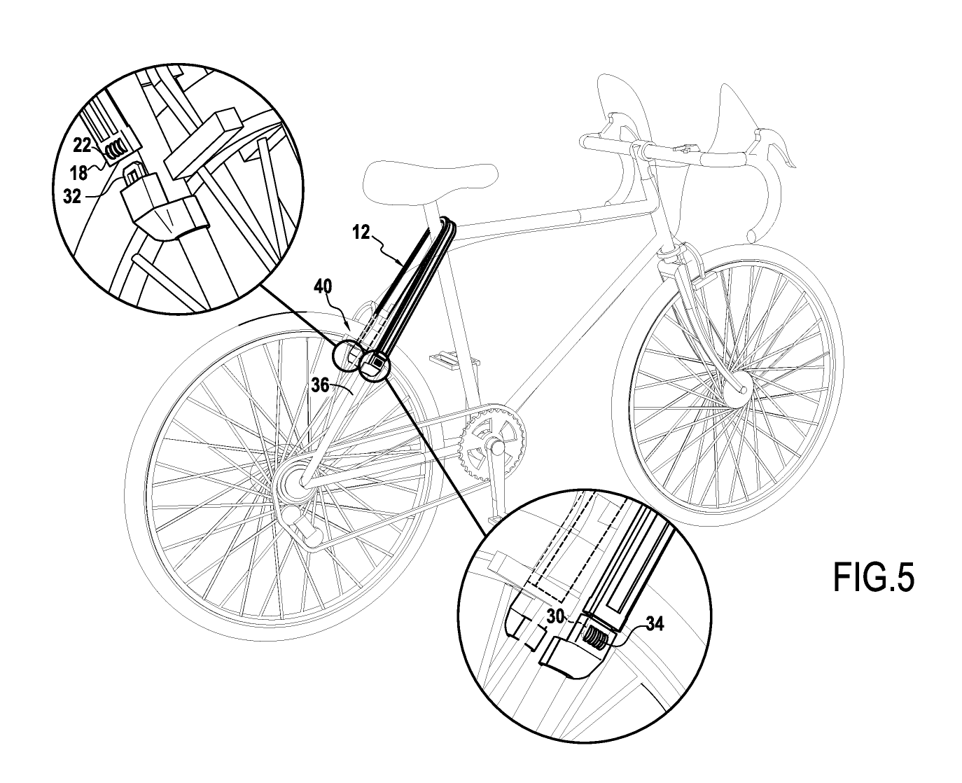

FIG. 5 shows a way of locking the anti-theft device 10 of the invention on the vehicle when the anti-theft device 10 is not used to secure the vehicle; the figure shows the step following locking of the anti-theft device 10 on the vehicle.

Closure elements 30 and 32, similar to closure elements 18 and 16 arranged at the ends of the anti-theft device 10, are provided to be fastened on the vehicle; e.g. in the context of an application of the anti-theft device 10 in order to secure a bicycle, the closure elements 30 and 32 are arranged on the frame 36 of the bicycle.

The closure element 30 is of the female type; it co-operates with the male closure element 16 and is provided with a locking system 34 similar to the locking system 22 present on the female closure element 18 of the second portion 14 of the anti-theft device; in similar manner, the closure element 32 is of the male type and co-operates with the female closure element 18.

When the anti-theft device 10 is not used in its function for securing a bicycle, it may then be locked to the frame of the bicycle; the female closure element 30 associated with the locking system 34 ensures locking of the male closure element 16 and the female closure element 32 ensures locking of the female closure element 18 in association with the locking system 22.

Moreover, as shown in particular on FIGS. 2A to 2H that have been previously described, the flexible line 12 has a longitudinal indentation, formed between two beveled longitudinal edges 25, this longitudinal indentation being designed to comply with the shape of the tubes of the bicycle frame so as to improve the stability of the anti-theft device 10 when it is locked on the bicycle.

The closure elements 30 and 32 associated with the anti-theft device 10 constitute anti-theft equipment 40.

The whole of the above description is given by way of example, and is therefore not limiting on the invention.

In particular, the invention, although particularly adapted to the field of anti-theft devices for bicycle equipment, extends to other transport means, such as motorbikes or scooters, and more generally, to any field that may require the use of an anti-theft device.

1. An anti-theft device of the collar type comprising a flexible line composed of reinforcing elements embedded in a thickness of elastomer material, said reinforcing elements being arranged in the elastomer material so as to confer to said flexible line flexibility an overall cut resistance, wherein at least some of said reinforcing elements are spaced from each other, so that they are totally encompassed by the elastomer material.

2. The device according to claim 1, wherein at least some of the reinforcing elements extend longitudinally in the flexible line, in a substantially parallel manner to each other.

3. The device according to claim 1, wherein said reinforcing elements present selected differing cut-resistance characteristics.

4. The device according to claim 1, wherein at least some reinforcing elements of superior cut resistance are located at the periphery of said flexible line.

5. The device according to claim 4, wherein at least some of said reinforcing elements located at the periphery of said flexible line are constituted of a material that is different from the material of the other reinforcing elements.

6. The device according to claim 4, wherein at least some of said reinforcing elements arranged at the periphery of said flexible line present sections that are greater than at least some of the reinforcing elements arranged in the core of said flexible line.

7. The device according to claim 4, wherein the reinforcing elements arranged in the core of said flexible line surround at least one reinforcing element of greater section.

8. The device according to claim 7, wherein said at least one reinforcing element of greater section is a flat strip.

9. The device according to claim 7, wherein said at least one reinforcing element of greater section is of helical shape.

10. The device according to claim 7, wherein the reinforcing elements arranged in the core of said flexible line surround at least two reinforcing elements of greater section arranged side by side.

11. The device according to claim 1, wherein the section of said flexible line is substantially rectangular.

12. The device according to claim 1, wherein the flexible line presents longitudinal edges and in that at least one of said longitudinal edges is beveled.

13. The device according to claim 12, wherein at least some reinforcing elements of superior cut resistance are arranged close to said longitudinal edges.

14. The device according to claim 1, wherein at least some of said reinforcing elements are made of metal.

15. The device according to claim 1, wherein each end of said flexible line is provided with a closure element.

16. The device according to claim 15, wherein said closure elements are provided with openings in which the reinforcing elements are engaged, the reinforcing elements being secured to the closure elements.

17. The device according to claim 15, wherein said closure elements co-operate with each other to constitute a latch, one of said closure elements being of male type, the other being of female type.

18. The device according to claim 17, wherein said latch constituted by the association of said closure elements is lockable.

19. Anti-theft equipment, comprising an anti-theft device according to claim 15 and two attachment elements suitable for being fastened on a vehicle to be secured.

20. Anti-theft equipment, comprising an anti-theft device according to claim 15 and two additional closure elements of male and female type suitable for being fastened on a vehicle to be secured.
